(19) United States
(12) Patent Application Publication
(10) Pub. No.: US 2014/0196566 A1
(43) Pub. Date: Jul. 17, 2014

(54) ROTATION ASSEMBLY

(71) Applicant: TAIWAN FU HSING INDUSTRIAL CO., LTD., Kaohsiung City (TW)

(72) Inventors: Chung-An Hsieh, Tainan City (TW); Jiun-Nan Shiu, Kaohsiung City (TW)

(73) Assignee: TAIWAN FU HSING INDUSTRIAL CO., LTD., Kaohsiung City (TW)

(21) Appl. No.: 13/803,665

(22) Filed: Mar. 14, 2013

(30) Foreign Application Priority Data
Jan. 17, 2013 (TW) 102101874

(51) Int. Cl. G05G 1/12

(52) U.S. Cl. CPC G05G 1/12
USPC 74/548

(57) ABSTRACT

A rotation assembly includes a sleeve, a catch and an elastic member, the sleeve comprises a central longitudinal axis, a ring wall, a first through hole and a constraining slot having a planar surface. The central longitudinal axis is surrounded by the ring wall, and the first through hole and the constraining slot are formed at the ring wall. The elastic member comprises a free end and a limiting end, the free end is engaged with the catch, and the limiting end is limited by the constraining slot to prevent the elastic member from separating from the sleeve while the rotation assembly is impact by an external force.

### FIELD OF THE INVENTION

The present invention is generally related to a rotation assembly, which particularly relates to the rotation assembly that prevents an elastic member from separation.

### BACKGROUND OF THE INVENTION

Please refer to FIG. 8, a conventional rotation assembly 300 means for engaging with a handle 400 comprises a body 310, a positioning plate 320 and an elastic member 330, wherein the body 310 comprises a penetration hole 311, an inner surface 312 and an accommodating space 313. One end of the elastic member 330 engages with the inner surface 312 of the body 310, and another end of the elastic member 330 contacts against the positioning plate 320 to make the positioning plate 320 protruded from the penetration hole 311 so that the rotation assembly 300 and the handle 400 are mutually engaged. However, when the rotation assembly 300 is impact by an external force or is installed incorrectly, which leads the positioning plate 320 to deflect or to separate from the elastic member 330 so as to make the rotation assembly 300 incapable of being applied.

### SUMMARY

The primary object of the present invention is to provide a rotation assembly. An elastic member of the present invention is limited by a constraining slot of a sleeve to prevent the elastic member from separating from the sleeve while the rotation assembly is impact by an external force.

A rotation assembly of the present invention engaged with a handle includes a sleeve, a catch and an elastic member, the sleeve comprises a central longitudinal axis, a ring wall, a first through hole and a constraining slot having a planar surface. The central longitudinal axis is surrounded by the ring wall, the handle is mounted around the ring wall, and the first through hole and the constraining slot are formed at the ring wall. The catch disposed within the sleeve protrudes from the ring wall via the first through hole thereby selectively engaging with or separating from the handle. The elastic member comprises a free end and a limiting end, the free end engages with the catch, and the limiting end is limited by the constraining slot and contacts against the planar surface. The elastic member is limited by the constraining slot in this invention, owning to the planar design of the constraining slot, the elastic member hardly generates sliding movement or rolling movement along the surface. Therefore, the elastic member is fixedly disposed within the sleeve to prevent the elastic member from separating from the sleeve while the rotation assembly is impacted by an external force so that the condition the rotation assembly failed to be used is avoidable.

### DESCRIPTION OF THE DRAWINGS

FIG. 1 is a perspective assembly view illustrating a rotation assembly and a handle in accordance with an embodiment of the present invention.

FIG. 2 is a perspective exploded view illustrating the rotation assembly and the handle in accordance with the embodiment of the present invention.

FIG. 3 is a lateral view illustrating the rotation assembly in accordance with the embodiment of the present invention.

FIG. 4 is a section view of FIG. 3 along A-A direction illustrating the rotation assembly.

FIG. 5 is a section view of FIG. 4 along B-B direction illustrating the rotation assembly.

FIG. 6 is a section view of FIG. 4 along C-C direction illustrating the rotation assembly.

FIG. 7 is an installation procedure of an elastic member of the rotation assembly in accordance with the embodiment of the present invention.

FIG. 8 is a section view illustrating a conventional rotation assembly.

### DETAILED DESCRIPTION OF THE INVENTION

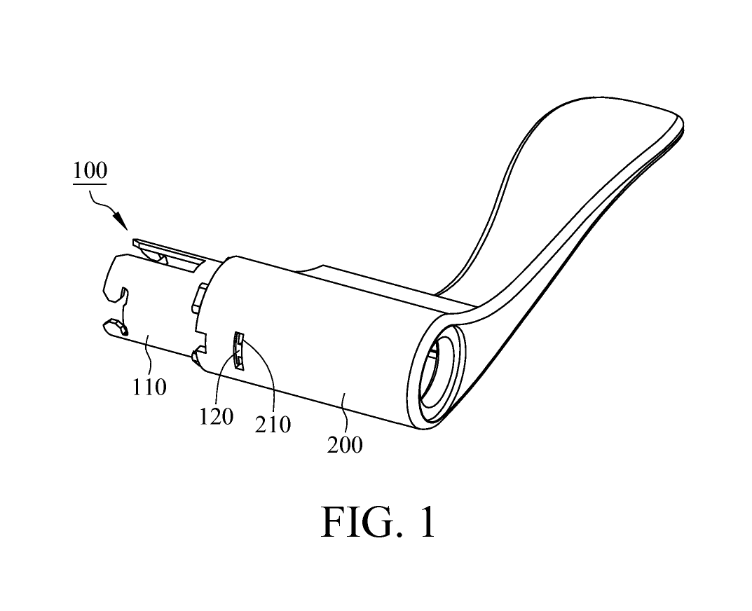

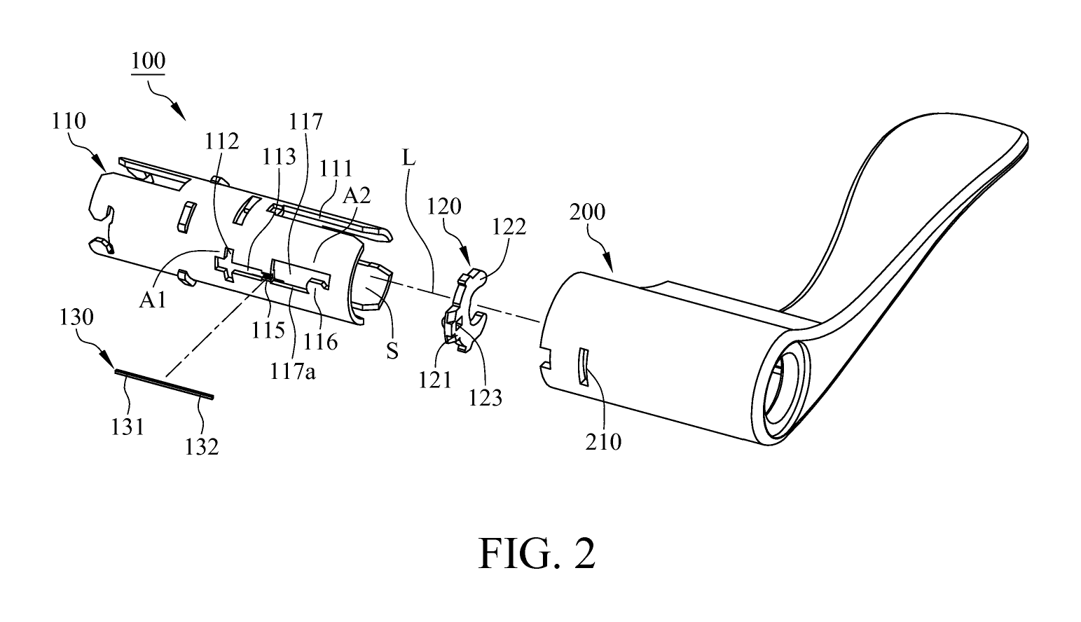

With reference to FIGS. 1, 2 and 3, a rotation assembly 100 utilized for engaging with a handle 200 having a positioning hole 210 includes a sleeve 110, a catch 120 and an elastic member 130, wherein the sleeve 110 comprises a central longitudinal axis L, a ring wall 111, a first through hole 112, a second through hole 113, a constraining slot 114 and an accommodating space S. The central longitudinal axis L is surrounded by the ring wall 111, the handle 200 is mounted around the ring wall 111, wherein the first through hole 112, the second through hole 113 and the constraining slot 114 are formed at the ring wall 111. The constraining slot 114 comprises a planar surface P, and the accommodating space S is surrounded by the ring wall 111. The catch 120 disposed inside the sleeve 110 protrudes from the ring wall 111 via the first through hole 112 thereby selectively engaging with or separating from the handle 200. In this embodiment, the catch 120 comprises a positioning portion 121, a fixing portion 122 and a fixing slot 123, the fixing portion 122 is disposed in the accommodating space S and connects to the positioning portion 121, and the fixing slot 123 is located between the positioning portion 121 and the fixing portion 122. Referring to FIGS. 2-4, the ring wall 111 of the sleeve 110 comprises a first area A1 and a second area A2 adjacent to the first area A1, the first through hole 112 and the second through hole 113 are located at the first area A1, the constraining slot 114 is located at the second area A2, and the second through hole 113 is located between the first through hole 112 and the constraining slot 114. In this embodiment, the first through hole 112 and the second through hole 113 penetrate through the ring wall 111, the first through hole 112 is in communication with the second through hole 113, wherein the first through hole 112 intersects the second through hole 113 to form a cross shape. The positioning portion 121 of the catch 120 protrudes from the ring wall 111 via the first through hole 112, and the positioning portion 121 is limited within the positioning hole 210 of the handle 200. The second area A2 comprises a support portion 115, a bearing portion 116 and a penetration hole 117 having a hole surface 117a, the second through hole 113 is located between the first through hole 112 and the constraining slot 114, the support portion 115 is located between the second through hole 113 and the penetration hole 117, and the bearing portion 116 protrudes from the hole surface 117a of the penetration hole 117. The support portion 115 comprises a first inner surface 115b facing toward the accommodating space S and a first outer surface 115a opposite to the first inner surface 115b, the bearing portion 116 comprises a second inner surface 116b facing toward the accommodating space S and a second outer surface 116a opposite to the second inner surface 116b.

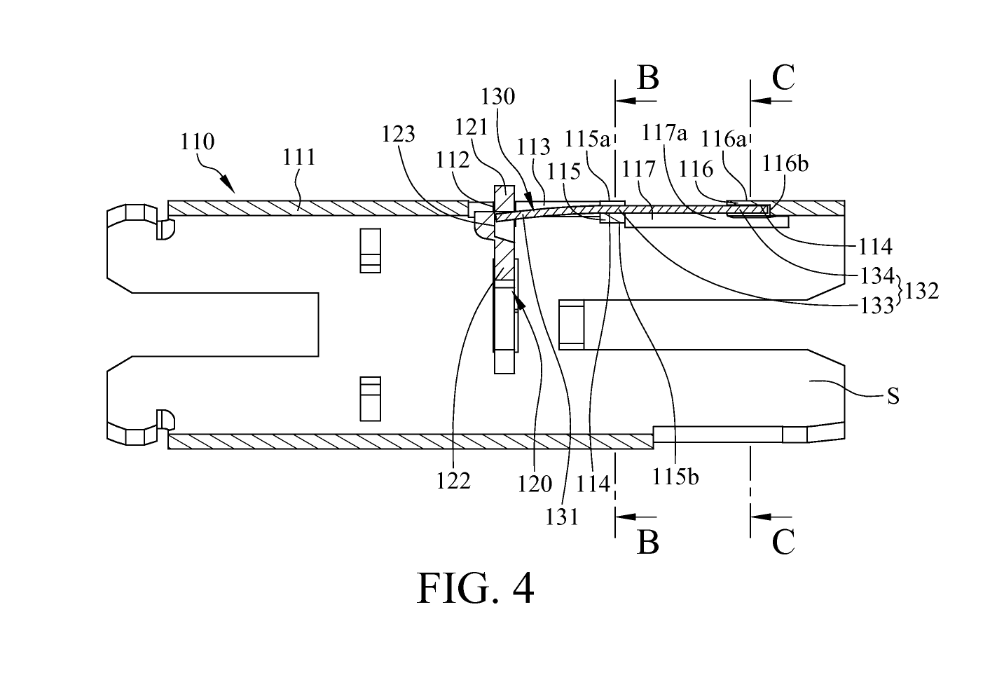

With reference to FIG. 4, the elastic member 130 comprises a free end 131 and a limiting end 132 connected to the free end 131. In this embodiment, the elastic member 130 is a rod-shaped elastic member, the free end 131 is engaged with the fixing slot 123 of the catch 120, the constraining slot 114 is recessed to the first outer surface 115a of the support portion 115, the limiting end 132 is limited by the constraining slot 114 and contacts against the planar surface P of the constraining slot 114, preferably the limiting end 132 of the elastic member 130 engages with the planar surface P of the constraining slot 114. In this embodiment, the limiting end 132 of the elastic member 130 comprises a support section 133 and a bearing section 134, wherein the support section 133 is located between the bearing section 134 and the free end 131, the support section 133 is limited within the constraining slot 114, and the bearing section 134 is limited within the bearing portion 116.

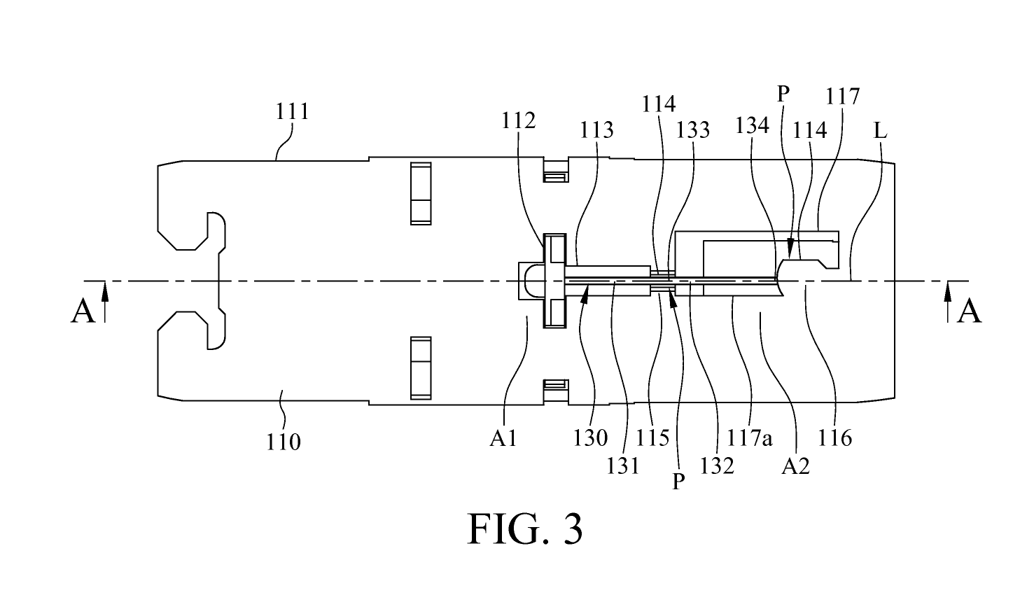

With reference to FIGS. 3 and 4, owning to the reasons that the elastic member 130 is disposed across the support portion 115 and the support section 133 is limited within the constraining slot 114 located at the support portion 115, which prevents the elastic member 130 from separating from the sleeve 110 so that the condition the rotation assembly 100 failed to be used is avoidable.

With reference to FIG. 4, in this embodiment, the constraining slot 114 is recessed to the second inner surface 116b of the bearing portion 116, wherein the bearing section 134 is limited within the constraining slot 114 so as to prevent the elastic member 130 from separating from the sleeve 110 so that the condition the rotation assembly 100 failed to be used is avoidable, or, the constraining slot 114 of the present invention is merely recessed to the first outer surface 115a of the support portion 115, or, the constraining slot 114 is merely recessed to the second inner surface 116b of the bearing portion 116.

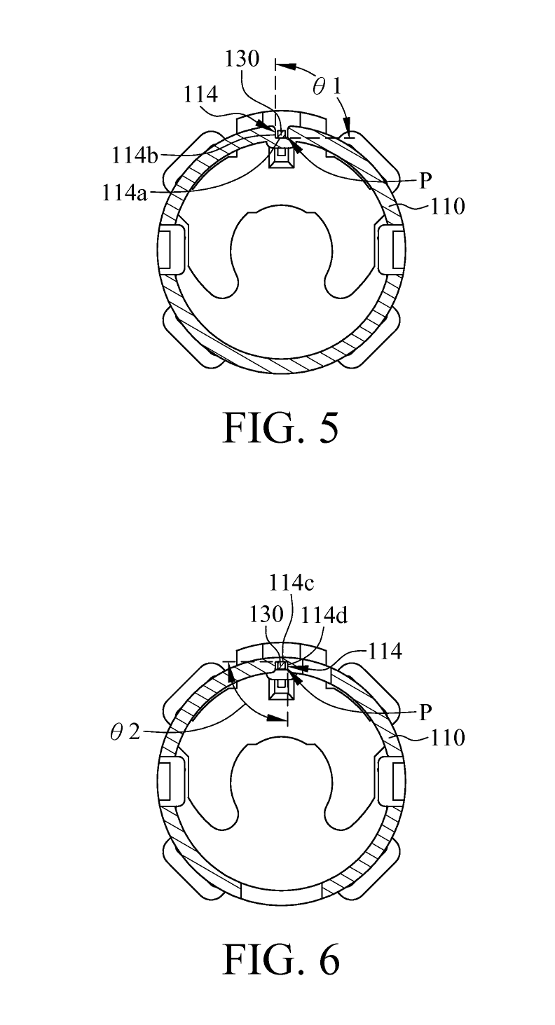

With reference to FIGS. 5 and 6, the transverse cross-section of the elastic member 130 is a square shape, the constraining slot 114 located at the support portion 115 comprises a first bottom surface 114a and a first lateral surface 114b inclined at a first angle θ1 to the first bottom surface 114a, the constraining slot 114 located at the bearing portion 116 comprises a second bottom surface 114c and a second lateral surface 114d inclined at a second angle θ2 to the second bottom surface 114c, wherein the first angle θ1 and the second angle θ2 are both 90 degrees. The elastic member 130 is fixedly limited within the constraining slot 114 for the reason that the transverse cross-section of the elastic member 130 and the constraining slots 114 are formed in square shape. Referring to FIGS. 3, 4 and 5, in this embodiment, the planar surface P is the first bottom surface 114a, the first lateral surface 114b, the second bottom surface 114c, or the second lateral surface 114d.

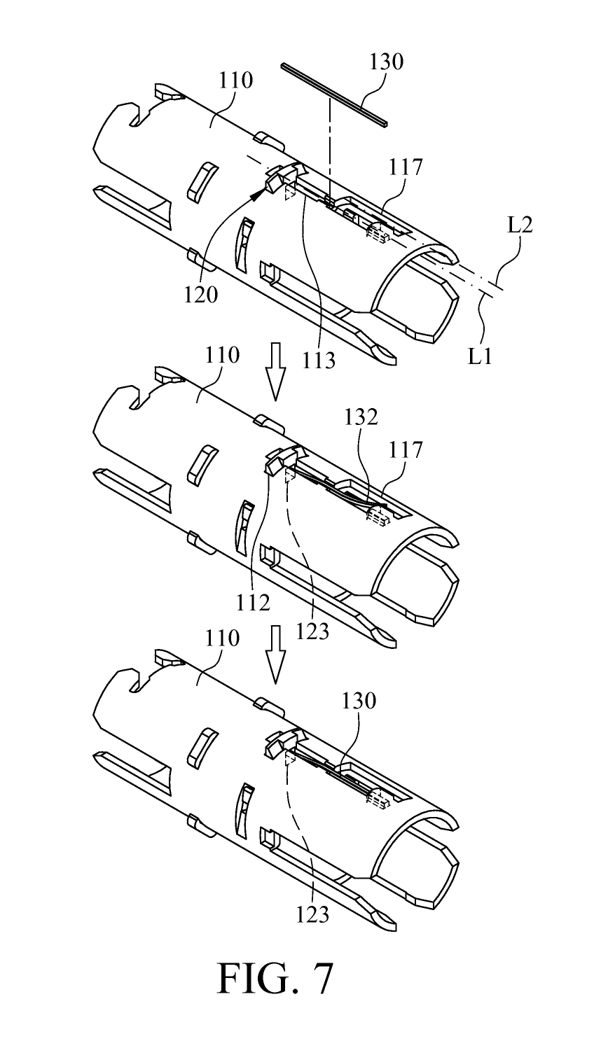

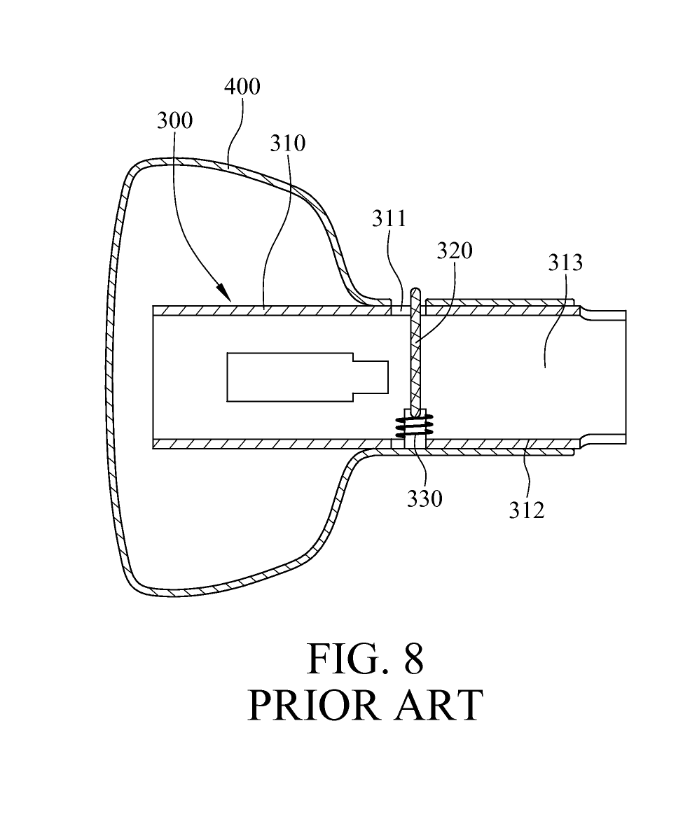

Referring to FIG. 7, the second through hole 113 comprises a first center line L1, the penetration hole 117 comprises a second center line L2, the first center line L1 and the second center line L2 are not arranged in the same straight line, the support portion 115 and the bearing portion 116 are located at the first center line L1. When the elastic member 130 is attached to the sleeve 110, the limiting end 132 bends toward the second center line L2 of the penetration hole 117, and thereafter the limiting end 132 will be disposed inside the constraining slot 114 via the penetration hole 117. Accordingly, the speed for attachment of the elastic member 130 is effectively increased.

The elastic member 130 is limited by the constraining slot 114 in the present invention, owning to the planar design of the constraining slot 114, the elastic member 130 hardly generates sliding movement or rolling movement along the surface. Therefore, the elastic member 130 is fixedly disposed within the sleeve 110 to prevent the elastic member 130 from separating from the sleeve 110 while the rotation assembly 100 is impacted by an external force so that the condition the rotation assembly 100 failed to be used is avoidable.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A rotation assembly engaged with a handle including:
a sleeve having a central longitudinal axis, a ring wall, a first through hole and a constraining slot, the central longitudinal axis is surrounded by the ring wall, the handle is mounted around the ring wall, the first through hole and the constraining slot are formed at the ring wall, and the constraining slot comprises a planar surface;
a catch disposed inside the sleeve, the catch protrudes from the ring wall via the first through hole thereby selectively engaging with or separating from the handle; and
an elastic member having a free end and a limiting end, the free end engages with the catch, the limiting end is limited by the constraining slot and contacts against the planar surface.

2. The rotation assembly in accordance with claim 1, wherein the ring wall comprises a first area and a second area adjacent to the first area, the sleeve further comprises a second through hole, wherein the first through hole and the second through hole communicated with the first through hole are located at the first area, the first through hole and the second through hole are formed in a cross shape, the constraining slot is located at the second area, and the second through hole is located between the first through hole and the constraining slot.

3. The rotation assembly in accordance with claim 2, wherein the second area comprises a support portion, a bearing portion and a penetration hole, the support portion is located between the second through hole and the penetration hole, the penetration hole comprises a hole surface, the bearing portion protrudes from the hole surface, the support portion comprises a first inner surface and a first outer surface opposite to the first inner surface, the bearing portion comprises a second inner surface and a second outer surface opposite to the second inner surface, the constraining slot is recessed to the first outer surface of the support portion.

4. The rotation assembly in accordance with claim 2, wherein the second area comprises a support portion, a bearing portion and a penetration hole, the support portion is located between the second through hole and the penetration hole, the penetration hole comprises a hole surface, the bearing portion protrudes from the hole surface, the support portion comprises a first inner surface and a first outer surface opposite to the first inner surface, the bearing portion comprises a second inner surface and a second outer surface opposite to the second inner surface, the constraining slot is recessed to the second inner surface of the bearing portion.

5. The rotation assembly in accordance with claim 3, wherein the constraining slot is recessed to the second inner surface of the bearing portion.

6. The rotation assembly in accordance with claim 3, wherein the limiting end of the elastic member comprises a support section and a bearing section, the support section limited within the constraining slot is located between the bearing section and the free end, the bearing section is in contact against the bearing portion.

7. The rotation assembly in accordance with claim 4, wherein the limiting end of the elastic member comprises a support section and a bearing section, the support section is located between the bearing section and the free end, the bearing section is limited within the constraining slot, the support section is in contact against the support portion.

8. The rotation assembly in accordance with claim 5, wherein the limiting end of the elastic member comprises a support section and a bearing section, the support section is located between the bearing section and the free end, the support section is limited within the constraining slot located at the support portion, and the bearing section is limited within the constraining slot located at the bearing portion.

9. The rotation assembly in accordance with claim 1, wherein the constraining slot comprises a first bottom surface and a first lateral surface, the first bottom surface is inclined at a first angle to the first lateral surface, and the first angle is 90 degrees.

10. The rotation assembly in accordance with claim 1, wherein the transverse cross-section of the elastic member is a square shape.

11. The rotation assembly in accordance with claim 1, wherein the limiting end of the elastic member engages with the planar surface of the constraining slot.
